(19) United States
(12) Patent Application Publication
(10) Pub. No.: US 2014/0268831 A1
(43) Pub. Date: Sep. 18, 2014

(54) HEAT DISSIPATING DEVICE AND ILLUMINATION DEVICE HAVING THE SAME

(71) Applicant: Jun Zhan Technology Co., LTD., Tainan City (TW)

(72) Inventors: Chuan-Feng Shih, Tainan City (TW); Sheng-Wen Fu, Tainan City (TW); Hsuan-Ta Wu, Tainan City (TW); Chih-Ming Lai, Tainan City (TW); Jon-Lian Kwo, Tainan City (TW)

(73) Assignee: Jun Zhan Technology Co., LTD., Tainan City (TW)

(21) Appl. No.: 14/188,706

(22) Filed: Feb. 25, 2014

(30) Foreign Application Priority Data
Mar. 12, 2013 (TW) 102108661
Mar. 15, 2013 (TW) 102109306
Jul. 17, 2013 (TW) 102304914
Sep. 26, 2013 (TW) 102134798

(51) Int. Cl. F21V 29/00

(52) U.S. Cl. CPC F21V 29/30
USPC 362/382; 165/168

(57) ABSTRACT

A heat dissipating device includes a main body and a working fluid. The main body has a plurality of hollow chambers formed therein. The working fluid is disposed in the plurality of hollow chambers. The plurality of hollow chambers may be communicated or not communicated with each other.

### BACKGROUND OF THE INVENTION

1. Field of the Invention

The invention relates to a heat dissipating device and, particularly, to a heat dissipating device having a plurality of hollow chambers and more particularly, to an illumination device having the same.

2. Description of the Prior Art

A heat dissipating device is a significant component for semiconductor device. When a semiconductor device is operating, the current in circuits will generate unnecessary heat due to impedance. If the heat is accumulated in the electronic components of the semiconductor device without dissipating immediately, the electronic components may be damaged due to the accumulated heat. Therefore, the performance of a heat dissipating device is a significant issue for the semiconductor device, especially for a light emitting diode. When the temperature of the light emitting diode increases, the light emitting efficiency of the light emitting diode will decrease obviously and the life span of the light emitting diode will also decrease. As the light emitting diode is applied to various illumination devices gradually, the heat dissipating problem of the light emitting diode gets more and more significant.

In general, a conventional heat dissipating device has a hollow chamber for accommodating a working fluid, so as to dissipate heat. The working fluid can absorb heat and generate phase transition, so as to enhance the heat dissipating efficiency of the heat dissipating device. However, some specific portions of the heat dissipating device away from the hollow chamber cannot conduct heat to the working fluid rapidly, such that the heat dissipating efficiency of the specific portions of the heat dissipating device will get worse.

### SUMMARY OF THE INVENTION

An objective of the invention is to provide a heat dissipating device having a plurality of hollow chambers, so as to solve the aforesaid problems.

A heat dissipating device of the invention comprises a main body and a working fluid. The main body has a plurality of hollow chambers formed therein. The working fluid is disposed in the plurality of hollow chambers.

The invention further provides an illumination device having a heat dissipating device. The illumination device comprises a semiconductor element and a heat dissipating device. The heat dissipating device comprises a main body and a working fluid. The main body is coupled to the semiconductor element and has a plurality of hollow chambers formed therein. The working fluid is disposed in the plurality of hollow chambers and used for absorbing heat from the semiconductor element through the main body.

Compared with the prior art, the heat dissipating device of the invention has a plurality of hollow chambers distributed therein, wherein the plurality of hollow chambers accommodates the working fluid for dissipating heat. Accordingly, the main body of the heat dissipating device can transmit heat to each of the hollow chambers uniformly, so as to enhance the heat dissipating efficiency of the heat dissipating device. Needless to say, the illumination device of the invention also has better heat dissipating efficiency than the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a heat dissipating device according to a first embodiment of the invention.

FIG. 2 is a schematic view illustrating a heat dissipating device according to a second embodiment of the invention.

FIG. 3 is a schematic view illustrating a heat dissipating device according to a third embodiment of the invention.

FIG. 4 is a schematic view illustrating a heat dissipating device according to a fourth embodiment of the invention.

FIG. 5 is a schematic view illustrating a heat dissipating device according to a fifth embodiment of the invention.

FIG. 6 is a schematic view illustrating a heat dissipating device according to a sixth embodiment of the invention.

FIG. 7 is a schematic view illustrating a capillary structure on the inner surface of the hollow chamber.

FIG. 8 is a schematic view illustrating a heat dissipating device according to a seventh embodiment of the invention.

FIG. 9 is a schematic view illustrating an illumination device having a heat dissipating device of the invention.

FIG. 10 is a schematic view illustrating an illumination system of the invention.

FIG. 11 is a schematic view illustrating a cross-section of the heat dissipating device according to an embodiment of the invention.

FIG. 12 is a schematic view illustrating a cross-section of the heat dissipating device according to another embodiment of the invention.

FIG. 13 is a schematic view illustrating a cross-section of the heat dissipating device according to another embodiment of the invention.

### DETAILED DESCRIPTION

Referring to FIG. 1, FIG. 1 is a schematic view illustrating a heat dissipating device according to a first embodiment of the invention. As shown in FIG. 1, the heat dissipating device 100 of the invention comprises a main body 110 and a working fluid L. The main body 110 has a plurality of hollow chambers 112 formed therein. The working fluid L is disposed in the plurality of hollow chambers 112. The working fluid L can absorb heat and then generate phase transition. Since the plurality of hollow chambers 112 are distributed in the main body 110 uniformly, each portion of the heat dissipating device 100 can transmit heat to the working fluid L within neighbor hollow chamber 112 rapidly, so as to enhance the heat dissipating efficiency of the heat dissipating device 100. In the embodiment shown in FIG. 1, the plurality of hollow chambers 112 are not communicated with each other.

Referring to FIGS. 2 and 3, FIG. 2 is a schematic view illustrating a heat dissipating device according to a second embodiment of the invention, and FIG. 3 is a schematic view illustrating a heat dissipating device according to a third embodiment of the invention. As shown in FIG. 2, the plurality of hollow chambers 112 within the main body 210 may be communicated with each other through an accommodating space S1 formed at the bottom of the main body 210. Furthermore, as shown in FIG. 3, the plurality of hollow chambers 112 within the main body 310 may be communicated with each other through an accommodating space S1 formed at the bottom of the main body 310 and through an accommodating space S2 formed at the top of the main body 310.

In the aforesaid first to third embodiments, the heat dissipating devices 100, 200, 300 may be, but not limited to, formed integrally. For example, the heat dissipating devices 100, 200, 300 may be formed by a 3D printing process.

Referring to FIG. 4, FIG. 4 is a schematic view illustrating a heat dissipating device according to a fourth embodiment of the invention. As shown in FIG. 4, a first opening H1 may be formed on the bottom of the main body 410, the heat dissipating device 400 may further comprise a first cap C1, and the cap C1 is used for sealing the first opening H1 completely.

In the fourth embodiment, the working fluid L may be filled in the main body 410 through the first opening H1, and the air within the main body 410 may also be exhausted through the first opening H1, so as to enable the remaining space within the main body 410 to be a vacuum state. Afterward, the first cap C1 may be connected to the first opening H1 of the main body 410 by a low-temperature welding process, a welding process, an adhesion process, a hot press process, an ultrasound welding process, or other processes, so as to form an airtight space in the main body 410.

Referring to FIG. 5, FIG. 5 is a schematic view illustrating a heat dissipating device according to a fifth embodiment of the invention. As shown in FIG. 5, in addition to the first opening H1 formed on the bottom of the main body 510, a second opening H2 may also be formed on the top of the main body 510 and opposite to the first opening H1. Furthermore, the heat dissipating device 500 may further comprise a second cap C2 and the second cap C2 is used for sealing the second opening H2 completely.

In the fifth embodiment, the first cap C1 may be connected to the bottom of the main body 510 first, so as to seal the first opening H1. The first cap C1 may be connected to the bottom of the main body 510 by a low-temperature welding process, a welding process, an adhesion process, a hot press process, an ultrasound welding process, or other processes. After the first opening H1 is sealed by the first cap C1, the working fluid L may be filled in the main body 510 through the second opening H2 of the main body 510, and the air within the main body 510 may also be exhausted through the second opening H2, so as to enable the remaining space within the main body 510 to be a vacuum state. Afterward, the second opening H2 of the main body 510 is sealed by the second cap C2, so as to form an airtight space in the main body 510. The second cap C2 may be connected to the top of the main body 510 by a low-temperature welding process, a welding process, an adhesion process, a hot press process, an ultrasound welding process, or other processes, so as to seal the second opening H2.

Referring to FIG. 6, FIG. 6 is a schematic view illustrating a heat dissipating device according to a sixth embodiment of the invention. As shown in FIG. 6, the second cap C2′ may have a passage 120. In the embodiment shown in FIG. 6, the passage 120 is, but not limited to, L-shaped. When the hollow chambers 112 of the main body 610 are vacuumized during the processing of manufacturing the heat dissipating device 600, the air within the hollow chambers 112 of the main body 610 can be exhausted out of the main body 610 through the passage 120 of the second cap C2′. Afterward, the second opening H2 of the main body 610 is sealed by the second cap C2′ completely, so as to enable the hollow chambers 112 of the main body 610 to be a vacuum state.

In the aforesaid embodiments, a plurality of capillary structures are disposed on inner surfaces of the plurality of hollow chambers, respectively. Referring to FIG. 7, FIG. 7 is a schematic view illustrating a capillary structure on the inner surface of the hollow chamber. As shown in FIG. 7, a plurality of grooves 116 may be formed on the inner surface of the hollow chamber 112 and function as capillary structures, wherein the width of the groove 116 is larger than or equal to 0.01 mm and smaller than or equal to 5 mm, the depth of the groove 116 is larger than or equal to 0.01 mm and smaller than or equal to 5 mm, and the pitch between two grooves 116 is larger than or equal to 0.01 mm and smaller than or equal to 5 mm. Furthermore, in addition to rectangular shape, the cross-section of the groove 116 may also be V-shaped, ladder-shaped, reversed ladder-shaped, U-shaped, or other shapes.

Moreover, as shown in FIGS. 4 to 6, to further enhance the heat dissipating efficiency, a plurality of grooves 116 may also be formed on a surface of the first cap C1 facing the first opening H1, so as to assist the working fluid L in flowing on the first cap C1. Still further, the groove 116 may be formed as a hole, such as a blind hole.

Referring to FIG. 8, FIG. 8 is a schematic view illustrating a heat dissipating device according to a seventh embodiment of the invention. As shown in FIG. 8, the main body may further comprise a plurality of extending portions 130, wherein the extending portions 130 extend from an outer surface of the main body, so as to increase the heat dissipating area of the main body and further enhance the heat dissipating efficiency. The extending portions 130 and the main body may be formed integrally or independently. The shape of the extending portion 130 is not limited to the embodiment shown in FIG. 8.

Referring to FIG. 9, FIG. 9 is a schematic view illustrating an illumination device having a heat dissipating device of the invention. As shown in FIG. 9, the illumination device 10 of the invention comprises a semiconductor element D and a heat dissipating device 900. The semiconductor element D may comprise, but not limited to, a light emitting diode, a photo diode, a photovoltaic cell, solar cell, an electro-luminance light emitting diode, a laser diode, a power amplifier, an integrated circuit element, and so on. The heat dissipating device 900 comprises a main body 910 and a working fluid L. The main body 910 is coupled to the semiconductor element D and has a plurality of hollow chambers 112 formed therein. The working fluid L is disposed in the plurality of hollow chambers 112 and used for absorbing heat from the semiconductor element D. In the embodiment shown in FIG. 9, an opening H1 is formed on an end of the main body 910 and the semiconductor element D covers the opening H1 directly, so as to seal the opening H1 completely. For example, the heat dissipating device 900 of the illumination device 10 may be any one of the heat dissipating devices shown in FIGS. 4 to 6, and the first cap C1 may be replaced by the semiconductor element D for sealing the first opening H1 completely. According to the aforesaid arrangement, the semiconductor element D contacts the working fluid L directly rather than conducting heat by thermal grease or other heat conducting materials. Accordingly, the heat dissipating efficiency of the illumination device 10 of the invention can be enhanced.

However, in other embodiments of the invention, the heat dissipating device of the illumination device may also be any one of the heat dissipating devices shown in FIGS. 1 to 3, and the semiconductor element may be coupled to the heat dissipating device by thermal grease or other heat conducting materials.

Furthermore, the main body of the illumination device of the invention may also comprise a plurality of extending portions, so as to increase the heat dissipating area of the main body.

Referring to FIG. 10, FIG. 10 is a schematic view illustrating an illumination system of the invention. As shown in FIG. 10, the illumination system 1 of the invention comprises a frame 12, a plurality of heat dissipating devices 1000 and a plurality of semiconductor elements D. The frame 12 has at least one hollow structure 102. The heat dissipating device 1000 may be any one of the aforesaid heat dissipating devices and the main body of the heat dissipating device 1000 may also comprise a plurality of extending portions 132. The semiconductor element D is disposed on a heat absorbing end of the heat dissipating device 1000.

According to the aforesaid arrangement, since the extending portions 132 extend from the periphery of the main body radially, the cold air around the heat dissipating device 1000 can contact the heat dissipating device directly for heat exchange without obstruction due to the extending portions 132. Moreover, since the extending portions 132 are exposed within the hollow structures 102 of the frame 12, the hot air around the semiconductor element D can flow in the gap between the hollow structure 102 and the extending portion 132, so as to form natural thermal convection, i.e. the thermal convection will not be blocked and reduced by the frame 12.

Referring to FIGS. 11 to 13, FIG. 11 is a schematic view illustrating a cross-section of the heat dissipating device according to an embodiment of the invention, FIG. 12 is a schematic view illustrating a cross-section of the heat dissipating device according to another embodiment of the invention, and FIG. 13 is a schematic view illustrating a cross-section of the heat dissipating device according to another embodiment of the invention. As shown in FIG. 11, the contour of the main body may be circular and the contour of the hollow chamber may also be circular. As shown in FIG. 12, the contour of the main body may be rectangular and the contour of the hollow chamber may also be rectangular. As shown in FIG. 13, the contour of the main body may be hexagonal and the contour of the hollow chamber may also be triangular.

The cross-section of the heat dissipating device of the invention is not limited to the aforesaid embodiments. The cross-sections of the main body and the hollow chambers of the invention may be circular, polygonal or the combination thereof according to practical applications.

Still further, in the embodiments of the invention, the working fluid L at least comprises water, methyl alcohol, ethyl alcohol, ethylene glycol, propylene glycol, acetone, ammonium hydroxide, paraffin, oil, chlorofluorocarbons (CFCs), other cooling liquids (e.g. 3M®Flourinert or 3M®Novec), or the combination thereof.

Compared with the prior art, the heat dissipating device of the invention has a plurality of hollow chambers distributed therein, wherein the plurality of hollow chambers accommodates the working fluid for dissipating heat. Accordingly, the main body of the heat dissipating device can transmit heat to each of the hollow chambers uniformly, so as to enhance the heat dissipating efficiency of the heat dissipating device. Needless to say, the illumination device of the invention also has better heat dissipating efficiency than the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A heat dissipating device comprising:
a main body having a plurality of hollow chambers formed therein; and
a working fluid disposed in the plurality of hollow chambers.

2. The heat dissipating device of claim 1, wherein the plurality of hollow chambers are not communicated with each other.

3. The heat dissipating device of claim 1, wherein the plurality of hollow chambers are communicated with each other.

4. The heat dissipating device of claim 1, wherein a first opening is formed on an end of the main body, the heat dissipating device further comprises a first cap, and the first cap seals the first opening completely.

5. The heat dissipating device of claim 4, wherein a plurality of grooves are formed on a surface of the first cap facing the first opening.

6. The heat dissipating device of claim 4, wherein a second opening is formed on another end of the main body and opposite to the first opening, the heat dissipating device further comprises a second cap, and the second cap seals the second opening completely.

7. The heat dissipating device of claim 6, wherein the second cap has a passage.

8. The heat dissipating device of claim 1, wherein a plurality of capillary structures are disposed on inner surfaces of the plurality of hollow chambers, respectively.

9. The heat dissipating device of claim 1, wherein the main body further comprises a plurality of extending portions.

10. The heat dissipating device of claim 9, wherein the extending portions extend from an outer surface of the main body radially.

11. An illumination device comprising:
a semiconductor element; and
a heat dissipating device comprising:
a main body connected to the semiconductor element, the main body having a plurality of hollow chambers formed therein; and
a working fluid disposed in the plurality of hollow chambers and used for absorbing heat from the semiconductor element.

12. The illumination device of claim 11, wherein the plurality of hollow chambers are not communicated with each other.

13. The illumination device of claim 11, wherein the plurality of hollow chambers are communicated with each other.

14. The illumination device of claim 11, wherein a first opening is formed on an end of the main body and the semiconductor element covers the first opening directly, so as to seal the first opening completely.

15. The illumination device of claim 14, wherein a plurality of grooves are formed on a surface of the semiconductor element facing the first opening.

16. The illumination device of claim 14, wherein a second opening is formed on another end of the main body and opposite to the first opening, the heat dissipating device further comprises a cap, and the cap seals the second opening completely.

17. The illumination device of claim 16, wherein the cap has a passage.

18. The illumination device of claim 11, wherein a plurality of capillary structures are disposed on inner surfaces of the plurality of hollow chambers, respectively.

19. The illumination device of claim 11, wherein the main body further comprises a plurality of extending portions.

20. The illumination device of claim 19, wherein the extending portions extend from an outer surface of the main body radially.
